(19) United States
(12) Patent Application Publication
(10) Pub. No.: US 2008/0081895 A1
(43) Pub. Date: Apr. 3, 2008

(54) POLYCARBONATE-POLYSILOXANE COPOLYMERS, METHOD OF MAKING, AND ARTICLES FORMED THEREFROM

(75) Inventors: Jan Pleun Lens, Breda (NL); Brian D. Mullen, Mount Vernon, IN (US)

Correspondence Address: CANTOR COLBURN LLP - SABIC (LEXAN/CYCOLOY), 20 Church Street, 22nd Floor, Hartford, CT, 06103, US

(73) Assignee: GENERAL ELECTRIC COMPANY, Schenectady, NY (US)

(21) Appl. No.: 11/536,986

(22) Filed: Sep. 29, 2006

(51) Int. Cl. C08G 64/00

(52) U.S. Cl. 528/196

(57) ABSTRACT

A polycarbonate copolymer comprising 40 to 89 mol % of units derived from a bisphenol of the formula

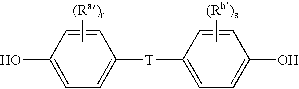

wherein R^{a′} and R^{b′} are each independently C₁₋₁₂ alkyl, T is a C₅₋₁₆ cycloalkylene, a C₅₋₁₆ cylcloalkyliden, a C₁₋₅ alkylene, a C₁₋₅ alkylidene, a C₆₋₁₃ arylene, a C₇₋₁₂ arylalkylene, C₇₋₁₂ arylalkylidene, a C₇₋₁₂ alkylarylene, or a C₇₋₁₂ arylenealkyl, and r and s are each independently 1 to 4; 2 to 35 wt. % of units derived from a polysiloxane diol of the formulas

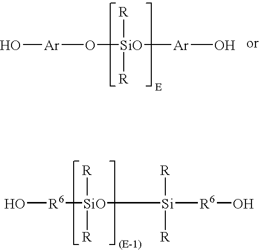

or a combination thereof, wherein Ar is a substituted or unsubstituted C₆₋₃₆ arylene group, each R is the same or different C₁₋₁₃ monovalent organic group, each R⁶ is the same or different divalent C₁-C₃₀ organic group, and E is an integer from 4 to 100; and 11 to 60 mol % of units derived from a dihydroxy aromatic compound of formula (3)

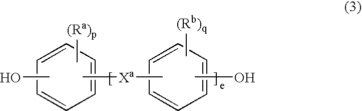

wherein R^{a} and R^{b} are each independently a halogen or C₁₋₁₂ alkyl group, X^{a} is a direct bond or a C₁₋₁₈ organic group, p and q are each independently integers of 0 to 4, and the dihydroxy aromatic compound of formula (3) is not the same as the bisphenol of formula (1) or the polysiloxane diols. The polymers are of particular utility in medical applications.

### BACKGROUND

This disclosure relates to polycarbonates, and in particular to polycarbonate-polysiloxane copolymers, methods of manufacture, and uses thereof.

Polycarbonates are useful in the manufacture of articles and components for a wide range of applications, from automotive parts to medical devices. Polycarbonates having a high percentage of units derived from 1,1-bis(4-hydroxy-3-methylphenyl)cyclohexane (DMBPC) in particular have excellent attributes such as ammonia resistance, resistance to scratching, and water vapor and oxygen impermeability compared to other polycarbonates. At least in part because of these good barrier properties, such polycarbonates are useful in medical packaging applications. However, such polycarbonates are also brittle (of low ductility) compared to polycarbonates containing a high number of units derived from bisphenols such as bisphenol A. The addition of materials that can improve ductility, for example polydiorganosiloxane units, however, leads to increased haze in the compositions.

There accordingly remains a need in the art for polycarbonates that have improved haze, together with other advantageous properties, such as oxygen impermeability, water vapor impermeability, scratch resistance, and/or improved transparency.

### SUMMARY OF THE INVENTION

The above-described and other deficiencies of the art are met by a polycarbonate copolymer comprising 40 to 89 mol % of units derived from a bisphenol of formula (1)

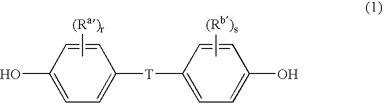

wherein R^{a′} and R^{b′} are each independently C₁₋₁₂ alkyl, T is a C₅₋₁₆ cycloalkylene, a C₅₋₁₆ cylcloalkyliden, a C₁₋₅ alkylene, a C₁₋₅ alkylidene, a C₆₋₁₃ arylene, a C₇₋₁₂ arylalkylene, C₇₋₁₂ arylalkylidene, a C₇₋₁₂ alkylarylene, or a C₇₋₁₂ arylenealkyl, and r and s are each independently 1 to 4; 2 to 35 wt. % of units derived from a diol of formula (2a) or (2b)

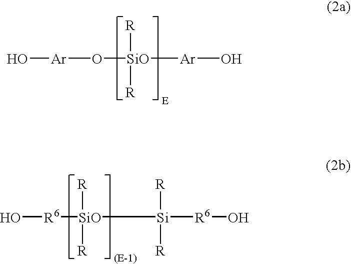

or a combination of (2a) and (2b), wherein Ar is a substituted or unsubstituted C₆₋₃₆ arylene group, each R is the same or different C₁₋₁₃ monovalent organic group, each R⁶ is the same or different divalent C₁₋₃₀ organic group, and E is an integer from 4 to 100; and 11 to 60 mol % of units derived from a dihydroxy aromatic compound of formula (3)

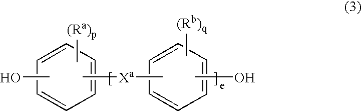

wherein R^{a} and R^{b} are each independently a halogen, X^{a} is a direct bond or a C₁₋₁₈ organic group, p and q are each independently integers of 0 to 4, and e is 0 or 1, wherein each of the foregoing mole percents is based on the total moles of bisphenol of formula (1) and dihydroxy aromatic compound of formula (3) used to manufacture the copolycarbonate, and the weight percent is based on the total weight of the bisphenol of formula (1), polysiloxane diols of formula (2a) and/or (2b), and dihydroxy aromatic compound of formula (3) used to manufacture the copolycarbonate.

In another embodiment, a copolycarbonate comprises 70 to 88 mol % of units derived from a cyclohexylidene bisphenol of the formula

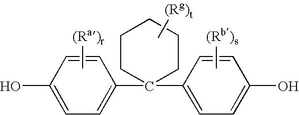

wherein R^{a′} and R^{b′} are each independently C₁₋₃ alkyl, R^{g} is C₁₋₃ alkyl or halogen, r and s are each independently 1 to 2, and t is 0 to 5;

3 to 8 wt. % of units derived from a polysiloxane diol of the formula

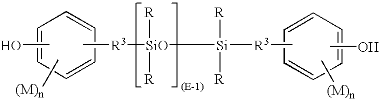

wherein each R is the same or different C₁₋₁₃ monovalent organic group, each R³ is the same or different divalent C₁-C₈ aliphatic group, M is bromo, chloro, a C₁₋₃ alkyl group, a C₁₋₃ alkoxy group, phenyl, chlorophenyl, or tolyl, and E is an integer from 5 to 55; and 12 to 30 mol % of units derived from a dihydroxy aromatic compound of formula

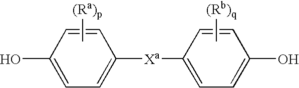

wherein R^{a} and R^{b} are each independently a halogen, X^{a} is a C₁₋₁₈ alkylene group, a C₃₋₁₈ cycloalkylene group, or a fused C₆₋₁₈ cycloalkylene group, p and q are each independently integers of 0 to 1, and the dihydroxy aromatic compound is not the same as the cyclohexylidene bisphenol or the polysiloxane diols; and further wherein a molded sample consisting of the composition has a haze of less than about 5%, measured using 3.2 mm thick plaques according to ASTM-D1003-00.

In still another embodiment, a copolycarbonate comprises 70 to 88 mol % of units derived from a cyclohexylidene bisphenol of the formula

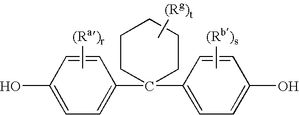

wherein r and s are each 1, R^{a′} and R^{b′} are each a methyl group disposed meta to the cyclohexylidene ring, R^{g} is C₁₋₃ alkyl or halogenand t is 0 to 5;

3 to 8 wt. % of units derived from a polysiloxane diol of the formula

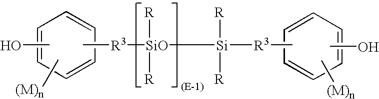

wherein each R is methyl, ach R³ is proplyene, M is bromo, chloro, a C₁₋₃ alkyl group, a C₁₋₃ alkoxy group, phenyl, chlorophenyl, or tolyl, and E is an integer from 5 to 55; and 12 to 30 mol % of units derived from a dihydroxy aromatic compound of formula

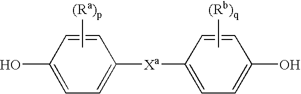

wherein p and q is each 0, X^{a} is isopropyledene; and further wherein a molded sample consisting of the composition has a haze of less than about 5%, measured using 3.2 mm thick plaques according to ASTM-D1003-00.

In another embodiment, a method of manufacture of the above-described polycarbonate copolymer comprises combining the bisphenol of formula (1), the diols of formulas (2a) and/or (2b), and the dihydroxy aromatic compound of formula (3) in the presence of a carbonyl source and a phase transfer catalyst at a pH of 6.0 to 13.0.

In another embodiment, a method of manufacture of a thermoplastic composition comprises blending the above-described polycarbonate copolymer with an additive to form a thermoplastic composition.

In yet another embodiment, an article comprises the above-described polycarbonate copolymer.

In still another embodiment, a method of manufacture of an article comprises molding, extruding, or shaping the above-described polycarbonate copolymer into an article.

The above described and other features are exemplified by the following detailed description.

### DETAILED DESCRIPTION OF THE INVENTION

Described herein is a polycarbonate copolymer derived from three different types of diols: an alkyl-substituted, cycloalkyl-bridged bisphenol, a polysiloxane-containing diol, and a bisphenol without alkyl substituents on the phenols. These copolymers (also referred to herein as “copolycarbonates”) have improved haze as well as other advantageous properties, such as oxygen impermeability, water vapor permeability, and/or transparency. The copolycarbonates are particularly useful in medical applications.

In particular, the copolycarbonates have repeating structural carbonate units of the formula (4):

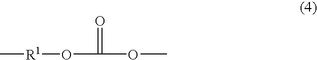

wherein the R¹ groups are derived from the least three different classes diols as described in detail below.

At least a portion of the R¹ groups of formula (4) are derived from an alkyl-substituted, cycloalkyl-bridged bisphenol of formula (1)

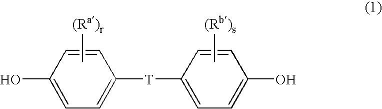

wherein R^{a′} and R^{b′} are each independently C₁₋₁₂ alkyl, T is a C₅₋₁₆ cycloalkylene, a C₅₋₁₆ cylcloalkylidene, a C₁₋₅ alkylene, a C₁₋₅ alkylidene, a C₆₋₁₃ arylene, a C₇₋₁₂ arylalkylene, C₇₋₁₂ arylalkylidene, a C₇₋₁₂ alkylarylene, or a C₇₋₁₂ arylenealkyl, and r and s are each independently 1 to 4. Specific T groups include C₅₋₁₆ cycloalkylene, C₅₋₁₆ cycloalkylidene, and C₆₋₁₃ arylene, wherein each of the foregoing groups are unsubstituted or substituted with an alkyl, aryl, alkoxy, or aryloxy group (up to the indicated total number of carbon atoms), halogen, —CN, —NO₂, —SH, or —OH Combinations of the substituents can be present.

In one embodiment, T is a cycloaliphatic group, in particular a C₅₋₁₆ cycloalkylidene that is unsubstituted or substituted with one or more of alkyl, aryl, alkoxy, or aryloxy group (up to the indicated total number of carbon atoms), halogen, —CN, —NO₂, —SH, or —OH. In another embodiment, T is a C₅₋₁₂ cyclopentylidene or cyclohexylidene that is unsubstituted or substituted with one or more alkyl groups.

Specifically, the units of formula (1) can be cycloalkylidene-bridged, alkyl-substituted bisphenols of formula (1a):

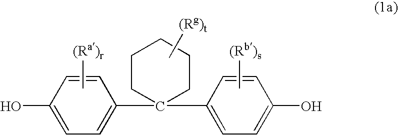

wherein R^{a′} and R^{b′} are each independently C₁₋₁₂ alkyl, R^{g} is C₁₋₁₂ alkyl or halogen, r and s are each independently 1 to 4, and t is 0 to 10. It will be understood that hydrogen fills each valency when r is 0, s is 0, and t is 0. In a specific embodiment, at least one of each of R^{a′} and R^{b′} are disposed meta to the cyclohexylidene bridging group. The substituents R^{a′}, R^{b′}, and R^{g} may, when comprising an appropriate number of carbon atoms, be straight chain, cyclic, bicyclic, branched, saturated, or unsaturated. In a specific embodiment, R^{a′}, R^{b′}, and R^{g} are each C₁₋₄ alkyl, specifically methyl. In still another embodiment, R^{a′}, R^{b′}, and R^{g} is a C₁₋₃ alkyl, specifically methyl, r and s are 1 or 2, and t is 0 to 5, specifically 0 to 3. Specifically, at least one of R^{a′} and/or R^{b′} are methyl, and are disposed meta to the bridging group. In another embodiment, the cyclohexylidene-bridged, alkyl-substituted bisphenol is 1,1-bis(4-hydroxy-3-methylphenyl)cyclohexane (“DMBPC”). In another embodiment, cycloalkylidene-bridged, alkyl-substituted bisphenol is the reaction product of two moles of cresol with one mole of a hydrogenated isophorone (1,1,3-trimethyl-3-cyclohexane-5-one).

The copolycarbonate further comprises polycarbonate units derived from a diol that contains diorganosiloxane (also referred to herein as “polysiloxane”) blocks of formula (5):

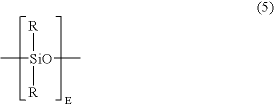

wherein each occurrence of R is same or different, and is a C₁₋₁₃ monovalent organic group. For example, R can be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkylaryl group, or C₇-C₁₃ alkylaryloxy group. The foregoing groups can be fully or partially halogenated with fluorine, chlorine, bromine, or iodine, or a combination thereof. In an embodiment, where a transparent copolycarbonate is desired, R does not contain any halogen. Combinations of the foregoing R groups can be used in the same copolycarbonate.

The value of E in formula (5) can vary widely depending on the type and relative amount of each of the different units in the copolycarbonate, the desired properties of the copolycarbonate, and like considerations. Generally, E can have an average value of 4 to 100. For transparent compositions, E is generally 4 to 60. In one embodiment, E has an average value of 5 to 55, and in still another embodiment, E has an average value of 40 to 60. Where E is of a lower value, e.g., less than about 40, it can be desirable to use a relatively larger amount of the units containing the polysiloxane. Conversely, where E is of a higher value, e.g., greater than about 40, it can be desirable to use a relatively lower amount of the units containing the polysiloxane.

In one embodiment, the polysiloxane blocks are provided by repeating structural units of formula (6):

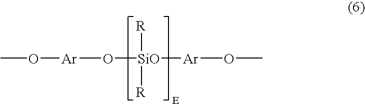

wherein E is as defined above; each R is the same or different, and is as defined above; and each Ar is the same or different, and is a substituted or unsubstituted C₆-C₃₀ arylene group, wherein the bonds are directly connected to an aromatic moiety. Ar groups in formula (6) can be derived from a C₆-C₃₀ dihydroxyarylene compound, for example a dihydroxyarylene compound of formula (3) or (12) described in detail below. Combinations comprising at least one of the foregoing dihydroxyarylene compounds can also be used. Exemplary dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulfide), 1,1-bis(4-hydroxy-3-methylphenyl)cyclohexane, and 1,1-bis(4-hydroxy-t-butylphenyl)propane, or a combination comprising at least one of the foregoing dihydroxy compounds.

Polycarbonates comprising such units can be derived from the corresponding dihydroxy compound of formula (2a):

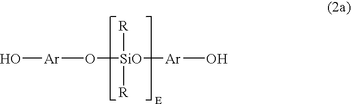

wherein Ar and E are as described above. Compounds of formula (2a) can be obtained by the reaction of a dihydroxyarylene compound with, for example, an alpha, omega-bis-acetoxy-polydiorganosiloxane oligomer under phase transfer conditions. Compounds of formula (2a) can also be obtained from the condensation product of a dihydroxyarylene compound, with, for example, an alpha, omega bis-chloro-polydimethylsiloxane oligomer in the presence of an acid scavenger.

In another embodiment, polydiorganosiloxane blocks comprises units of formula (7):

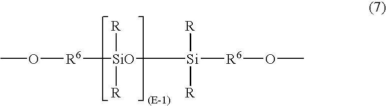

wherein R and E are as described above, and each R⁶ is independently a divalent C₁-C₃₀ organic group, and wherein the oligomerized polysiloxane unit is the reaction residue of its corresponding dihydroxy compound. In a specific embodiment, the polydiorganosiloxane blocks are provided by repeating structural units of formula (8):

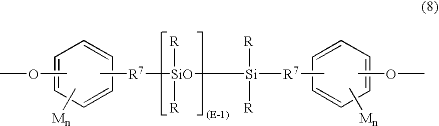

wherein R and E are as defined above. R⁷ in formula (8) is a divalent C₂-C₈ aliphatic group. Each M in formula (8) can be the same or different, and is a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁷ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R⁷ is a divalent C₁-C₃ aliphatic group, and R is methyl.

Copolycarbonates comprising units of formula (7) can be derived from the corresponding dihydroxy polydiorganosiloxane (2b):

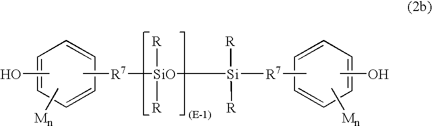

wherein each of R, E, M, R⁷, and n are as described above. Such dihydroxy polysiloxanes can be made by effecting a platinum-catalyzed addition between a siloxane hydride of formula (9):

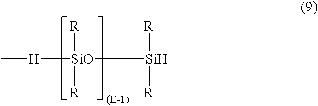

wherein R and E are as previously defined, and an aliphatically unsaturated monohydric phenol. Exemplary aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol, 4-allylphenol, and 2-allyl-4,6-dimethylphenol. Combinations comprising at least one of the foregoing can also be used.

The copolycarbonate further comprises units derived from a bisphenol that differs from the bisphenol of formula (1), and, of course, the diol containing a polysiloxane. The bisphenol is of the formula (3):

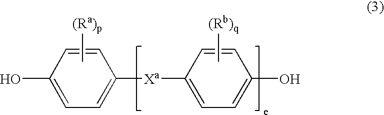

wherein R^{a} and R^{b} each represent a halogen and can be the same or different; p and q are each independently integers of 0 to 4; and e is 0 or 1. It will be understood that when p and/or q is 0, the valency will be filled by a hydrogen atom. Also in formula (3), when e is 1, X^{a} represents a single bond or a bridging group connecting the two hydroxy-substituted aryl groups such as, for example, phenol or o-cresol). In an embodiment, the bridging group X^{a} is a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, X^{a} is disposed para to each of the hydroxyl groups on the phenyl ring.

In an embodiment, X^{a} is one of the groups of formula (10):

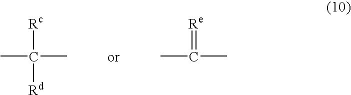

wherein R^{c} and R^{d} are each independently hydrogen, C₁₋₁₈ alkyl, cyclic C₁₋₁₂ alkyl, C₇₋₁₂ arylalkyl, C₁₋₁₂ heteroalkyl, or cyclic C₇₋₁₂ heteroarylalkyl, and R^{e} is a divalent C₁₋₁₂ hydrocarbon group.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylene group or a C₆₋₁₆ arylene group.

In still another embodiment, X^{a} is an acyclic C₁₋₁₈ alkylidene group, a C₃₋₁₈ cycloalkylidene group, or a C₂₋₁₈ heterocycloalkylidene group, i.e., a cycloalkylidene group having up to three heteroatoms in the ring, wherein the heteroatoms include —O—, —S—, or —N(Z)-, where Z is hydrogen, halogen, hydroxy, C₁₋₁₂ alkyl, C₁₋₁₂ alkoxy, or C₁₋₁₂ acyl.

X^{a} can be a substituted C₃₋₁₈ cycloalkylidene of the formula (11):

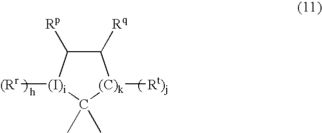

wherein each R^{r}, R^{p}, R^{q}, and R^{t} is independently hydrogen, halogen, oxygen, or C₁₋₁₂ organic group; I is a direct bond, a carbon, or a divalent oxygen, sulfur, or —N(Z)- wherein Z is hydrogen, halogen, hydroxy, C₁₋₁₂ alkyl, C₁₋₁₂ alkoxy, or C₁₋₁₂ acyl; h is 0 to 2, j is 0 to 2, i is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (11) will have an unsaturated carbon-carbon linkage where the ring is fused. When k is 1 and i is 0, the ring as shown in formula (11) contains 4 carbon atoms, when k is 2, the ring as shown contains 5 carbon atoms, and when k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group.

Some illustrative, non-limiting examples of suitable bisphenol compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy aromatic compounds.

Specific examples of the types of bisphenol compounds represented by formula (2) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PPPBP”), and 9,9-bis(4-hydroxyphenyl)fluorene. Combinations comprising at least one of the foregoing dihydroxy aromatic compounds can also be used.

Small amounts of other types of diols can be present in the copolycarbonate. For example, a small portion of R¹ can be derived from a dihydroxy aromatic compound of formula (12):

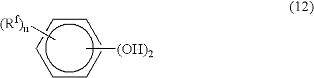

wherein each R^{f} is independently C₁₋₁₂ alkyl, or halogen, and u is 0 to 4. It will be understood that R^{f} is hydrogen when u is 0. Typically, the halogen can be chlorine or bromine. In an embodiment, compounds of formula (12) in which the —OH groups are substituted meta to one another, and wherein R^{f} and u are as described above, are also generally referred to herein as resorcinols. Examples of compounds that can be represented by the formula (12) include resorcinol (where u is 0), substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

The relative amount of each of the three types of units in the copolycarbonate will depend on the desired properties of the copolymer, and are readily ascertainable by one of ordinary skill in the art without undue experimentation, using the guidance provided herein. In general, the polycarbonate copolymer will comprise 40 to 89 mol %, specifically 50 to 89 mol %, more specifically 60 to 89 mol %, even more specifically 70 to 88 mol %, still more specifically 75 to 85 mol % of units derived from the bisphenol of formula (1). The polycarbonate copolymer will further comprise 2 to 35 wt. %, particularly 2 to 20 wt. %, even more particularly 2 to 10 wt. %, specifically 3 to 8 wt. %, even more specifically 3 to 6 wt. % of units derive from the diols of formulas (2a) and/or (2b). The polycarbonate will further comprise 11 to 60 mol %, specifically 11 to 50 mol %, more specifically 11 to 40 mole %, still more specifically 12 to 30 mol %, even more specifically 15 to 25 mol % of units derived from the dihydroxy aromatic compound of formula (3). Each of the foregoing mole percents is based on the total moles of the bisphenol of formula (1) and the dihydroxy aromatic compound of formula (3) used to manufacture the copolycarbonate, and the weight percent is based on the total weight of the bisphenol of formula (1), polysiloxane diols of formula (2a) and/or (2b), and dihydroxy aromatic compound of formula (3) used to manufacture the copolycarbonate.

Other types of dihydroxy monomers can be used in small amounts of up to 20 mol %, specifically up to 15 mol %, and even more specifically, 0.01 to 5 mol %. In one embodiment, the copolycarbonate consists essentially of units derived from the bisphenol (1), the dihycroxyaromatic compound (3), and the polysiloxane diol(s) (2a) and/or (2b), that is, no other monomers are used that significantly adversely affect the desired properties of the copolycarbonate. In another embodiment, only monomers that fall within the scope of formulas (1), (2a), (2b), and (3), specifically (1a), (2b), and (3) are used, that is, the copolycarbonate consists of the units derived from the foregoing dihydroxy aromatic compound, the alkyl-substituted, cycloalkyl-bridged bisphenol, and the polysiloxane diol(s).

It has been found that particularly advantageous results are obtained when the polycarbonate copolymer is obtained using to 70 to 88 mol %, specifically 75 to 85 mol %, of a bisphenol of formula (1a) wherein R^{a′} and R^{b′} are each independently C₁₋₃ alkyl, specifically methyl, R^{g} is C₁₋₃ alkyl, specifically methyl, r and s are each independently 1 to 2, specifically 1, and t is 0 to 5, specifically 0 or 3; 3 to 8 wt. %, specifically 3 to 6 wt. %, of a monomer of formula (2b) wherein each R is methyl, E is 4 to 60, specifically 5 to 55, each n is 0, and each R⁷ is a C₂₋₈ alkylene, specifically a C₃₋₇ alkylene; and 11 to 30 mol %, specifically 15 to 25 mol % of a monomer of formula (3) wherein each R^{a} and R^{b} are independently a C₁₋₃ alkyl group, specifically methyl, p and q are each 0, and X^{a} is a C₁₋₅ alkylidene, specifically isopropylidene.

The polycarbonates can be manufactured using an interfacial phase transfer process or melt polymerization as is known. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as, for example, triethylamine or a phase transfer catalyst salt, under controlled pH conditions, e.g., about 8 to about 10. Suitable phase transfer catalysts include compounds of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group.

Exemplary carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In one embodiment, the process uses phosgene as a carbonate precursor.

The water-immiscible solvent used to provide a biphasic solution includes, for example, methylene chloride, 1,2-dichloroethane, chlorobenzene, toluene, and the like.

It has been found that advantageous results can be obtained when the polycarbonate copolymer is made by a method in which chloroformates are generated from the monomer of formula (1), subsequently contacted with the polysiloxane diol monomer of formula (2a) and/or (2b), and stirred for and effective amount of time, e.g., 10 to 15 minutes, prior to reaction with the monomer of formula (3) and a carbonate precursor such as phosgene.

It has also been found that advantageous results can be obtained when the polycarbonate copolymer is made by a method in which mixtures of chloroformates are generated from the monomers of formula (1) and formula (3), subsequently contacted with the polysiloxane diol monomers of formula (2a) and/or (2b), and stirred for an effective time, e.g., 10 to 15 minutes, prior to reaction with additional monomers of formula (1), formula (3), and phosgene.

An end-capping agent (also referred to as a chain-stopper) can be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p-and tertiary-butyl phenol, cresol, and monoethers of diphenols, such as p-methoxyphenol. Alkyl-substituted phenols with branched chain alkyl substituents having 8 to 9 carbon atoms can be specifically mentioned. Certain monophenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Suitable monocarboxylic acid chlorides include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are monochloroformates including monocyclic monochloroformates, such as phenyl chloroformate, C₁-C₂₂ alkyl-substituted phenyl chloroformate, p-cumyl phenyl chloroformate, toluene chloroformate, and combinations thereof.

Various types of polycarbonate with branching groups are contemplated as being useful, provided that such branching does not significantly adversely affect desired properties of the compositions. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt. %. Mixtures comprising linear polycarbonates and branched polycarbonates can be used.

The polycarbonates can have a weight average molecular weight of about 5,000 to about 50,000, specifically about 10,000 to about 40,000, more specifically about 15,000 to about 35,000 as measured by gel permeation chromatography (GPC), using a crosslinked styrene-divinylbenzene column and calibrated to polycarbonate references. GPC samples are prepared at a concentration of about 1 mg/ml, and are eluted in methylene chloride or chloroform as a solvent at a flow rate of about 1.5 ml/min.

The copolycarbonates can further have a Notched Izod Impact (NII) of about 15 to about 40 Joules per square meter, J/m², or about 20 to about 30 J/m², measured at 23° C. using ⅛-inch thick bars (3.18 mm) in accordance with ASTM D256.

The copolycarbonates can further be manufactured to be substantially transparent, that is, without phase separation, pearlescence, flow lines or other visual defects detectable by the eye. In this case, the copolycarbonates have a haze of less than 25%, specifically less than 15%, still more specifically less than 10%, as measured using 3.2 mm thick plaques according to ASTM-D1003-00. In a specific embodiment, the copolycarbonates are transparent, that is, have a haze of less than about 5%, specifically less than about 3% as measured using 3.2 mm thick plaques according to ASTM-D1003-00.

In addition to the copolycarbonates described above, combinations of the polycarbonate with other thermoplastic polymers, for example homopolycarbonates, other polycarbonate copolymers comprising different R¹ moieties in the carbonate units, polyester carbonates, also known as a polyester-polycarbonates, and polyesters. These combinations can comprise 1 to 99 wt %, specifically 10 to 90, more specifically 20 to 80 wt. % of the copolycarbonate terpolymer, with the remainder of the compositions being other polymers and/or additives as described below.

For example, the thermoplastic composition can further include impact modifier(s), with the proviso that the additives are selected so as to not significantly adversely affect the desired properties of the thermoplastic composition. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than about 10° C., more specifically less than about −10° C., or more specifically about −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

Impact modifiers are generally present in amounts of 1 to 30 wt. %, based on the total weight of the polymers in the composition.

In addition to the polycarbonate resin, the thermoplastic composition can include various additives ordinarily incorporated in resin compositions of this type, with the proviso that the additives are selected so as to not significantly adversely affect the desired properties of the thermoplastic composition. Combinations of additives can be used. Such additives can be mixed at a suitable time during the mixing of the components for forming the composition.

Possible fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers and reinforcing agents can be coated with a layer of metallic material to facilitate conductivity, or surface treated with silanes to improve adhesion and dispersion with the polymeric matrix resin. In addition, the reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Exemplary co-woven structures include, for example, glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. Fillers are generally used in amounts of about 1 to about 20 parts by weight, based on 100 parts by weight of polycarbonate resin and any optional impact modifier.

Exemplary antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 to about 0.1 parts by weight, based on 100 parts by weight of polycarbonate resin and any optional impact modifier.

Exemplary heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of about 0.01 to about 0.1 parts by weight, based on 100 parts by weight of polycarbonate resin and any optional impact modifier.

Light stabilizers and/or ultraviolet light (UV) absorbing additives can also be used. Exemplary light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of about 0.01 to about 5 parts by weight, based on 100 parts by weight of polycarbonate resin and any optional impact modifier.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3,3-diphenylacryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to about 100 nanometers; or the like, or combinations comprising at least one of the foregoing UV absorbers. UV absorbers are generally used in amounts of about 0.01 to about 5 parts by weight, based on 100 parts by weight of polycarbonate resin and any optional impact modifier.

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol)copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. Such materials are generally used in amounts of about 0.1 to about 1 parts by weight, based on 100 parts by weight of polycarbonate resin and any optional impact modifier.

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT® 6321 (Sanyo) or PEBAX® MH1657 (Atofina), IRGASTAT® P18 and P22 (Ciba-Geigy). Other polymeric materials that can be used as antistatic agents are inherently conducting polymers such as polyaniline (commercially available as PANIPOL® EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or a combination comprising at least one of the foregoing can be used in a polymeric resin containing chemical antistatic agents to render the composition electrostatically dissipative. Antistatic agents are generally used in amounts of about 0.05 to about 0.5 parts by weight, based on 100 parts by weight of polycarbonate resin and any optional impact modifier.

Colorants such as pigment and/or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amounts of about 0.001 to about 3 parts by weight, based on 100 parts by weight of polycarbonate resin and any optional impact modifier.

Exemplary dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes are generally used in amounts of about 0.0001 to about 5 parts by weight, based on 100 parts by weight of polycarbonate resin and any optional impact modifier.

Where a foam is desired, useful blowing agents include for example, low boiling halohydrocarbons and those that generate carbon dioxide; blowing agents that are solid at room temperature and when heated to temperatures higher than their decomposition temperature, generate gases such as nitrogen, carbon dioxide, and ammonia gas, such as azodicarbonamide, metal salts of azodicarbonamide, 4,4′oxybis(benzenesulfonylhydrazide), sodium bicarbonate, ammonium carbonate, or the like, or combinations comprising at least one of the foregoing blowing agents. Blowing agents are generally used in amounts of about 1 to about 20 parts by weight, based on 100 parts by weight of polycarbonate resin and any optional impact modifier.

Useful flame retardants include organic compounds that include phosphorus, bromine, and/or chlorine. Non-brominated and non-chlorinated phosphorus-containing flame retardants can be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkylaryl, or aralkyl group, provided that at least one G is an aromatic group. Two of the G groups can be joined together to provide a cyclic group, for example, diphenyl pentaerythritol diphosphate. Exemplary aromatic phosphates include, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

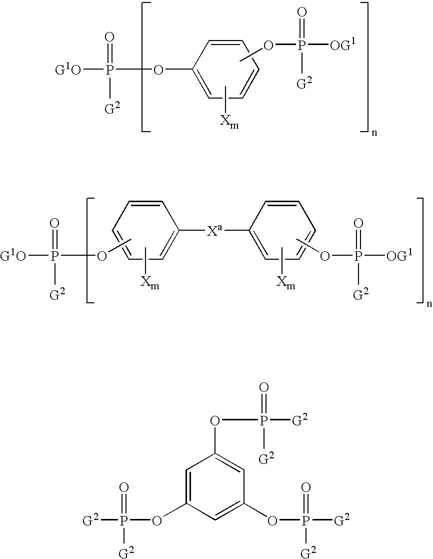

wherein each G¹ is independently a hydrocarbon having 1 to about 30 carbon atoms; each G² is independently a hydrocarbon or hydrocarbonoxy having 1 to about 30 carbon atoms; each X is independently a bromine or chlorine; m is 0 to 4, and n is 1 to about 30. Exemplary di- or polyfunctional aromatic phosphorus-containing compounds include resorcinol tetraphenyl diphosphate (RDP), the bis(diphenyl)phosphate of hydroquinone and the bis(diphenyl)phosphate of bisphenol-A, respectively, their oligomeric and polymeric counterparts, and the like.

Exemplary flame retardant compounds containing phosphorus-nitrogen bonds include phosphonitrilic chloride, phosphorus ester amides, phosphoric acid amides, phosphonic acid amides, phosphinic acid amides, tris(aziridinyl)phosphine oxide. When present, phosphorus-containing flame retardants are generally present in amounts of about

0.1 to about 30 parts by weight, more specifically about 1 to about 20 parts by weight, based on 100 parts by weight of polycarbonate resin and any optional impact modifier.

Halogenated materials can also be used as flame retardants, for example halogenated compounds and resins of formula (13):

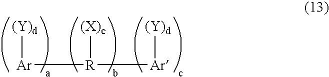

wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (13) are each independently mono- or polycarbocyclic aromatic groups such as phenylene, biphenylene, terphenylene, naphthylene, or the like.

Y is an organic, inorganic, or organometallic radical, for example (1) halogen, e.g., chlorine, bromine, iodine, fluorine or (2) ether groups of the general formula OB, wherein B is a monovalent hydrocarbon group similar to X or (3) monovalent hydrocarbon groups of the type represented by R or (4) other substituents, e.g., nitro, cyano, and the like, said substituents being essentially inert provided that there is greater than or equal to one, specifically greater than or equal to two, halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group can itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c can be 0. Otherwise either a or c, but not both, can be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants are generally present in amounts of about 1 to about 25 parts by weight, more specifically about 2 to about 20 parts by weight, based on 100 parts by weight of polycarbonate resin and any optional impact modifier.

Alternatively, the thermoplastic composition can be essentially free of chlorine and bromine. Essentially free of chlorine and bromine as used herein refers to materials produced without the intentional addition of chlorine or bromine or chlorine or bromine containing materials. It is understood however that in facilities that process multiple products a certain amount of cross contamination can occur resulting in bromine and/or chlorine levels typically on the parts per million by weight scale. With this understanding it can be readily appreciated that essentially free of bromine and chlorine can be defined as having a bromine and/or chlorine content of less than or equal to about 100 parts per million by weight (ppm), less than or equal to about 75 ppm, or less than or equal to about 50 ppm. When this definition is applied to the fire retardant it is based on the total weight of the fire retardant. When this definition is applied to the thermoplastic composition it is based on the total weight of the composition, excluding any filler.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. When present, inorganic flame retardant salts are generally present in amounts of about 0.01 to about 10 parts by weight, more specifically about 0.02 to about 1 parts by weight, based on 100 parts by weight of polycarbonate resin and any optional impact modifier.

Anti-drip agents can also be used in the composition, for example a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise about 50 wt. % PTFE and about 50 wt. % SAN, based on the total weight of the encapsulated fluoropolymer. The SAN can comprise, for example, about 75 wt. % styrene and about 25 wt. % acrylonitrile based on the total weight of the copolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer. Antidrip agents are generally used in amounts of 0.1 to 10 percent by weight, based on 100 percent by weight of polycarbonate resin and any optional impact modifier.

Radiation stabilizers can also be present, specifically gamma-radiation stabilizers. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-pene-2-ol, and 9-decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR⁴HOH or —CR₂⁴OH wherein R⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization. Gamma-radiation stabilizing compounds are typically used in amounts of 0.05 to 1 parts by weight based on 100 parts by weight of polycarbonate resin and any optional impact modifier.

Thermoplastic compositions comprising the copolycarbonate can be manufactured by various methods. For example, powdered copolycarbonate, other polymer (if present), and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a side stuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

Shaped, formed, or molded articles comprising the copolycarbonate compositions are also provided. The polycarbonate compositions can be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In addition, the polycarbonate compositions can be used for medical applications, such as syringe barrels, sample containers, medicament containers, plastic vials, blood housings, filter housings, membrane housings, plungers, and the like.

The copolycarbonates are further illustrated by the following non-limiting examples.

Polycarbonate terpolymers were made from monomers (14), (15), and (16):

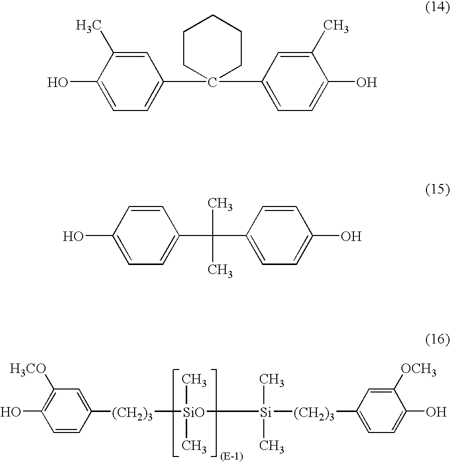

using the procedures below.

### EXAMPLE 1

The following were added into a 270-L continuously stirred tank reactor (CSTR) equipped with an overhead condenser and a recirculation pump with a flow rate of 40 L/minute: the bisphenol of formula (15) (2565 g, 11.25 mol); (b) the cyclohexylidene bisphenol of formula (14) (2850 g, 9.6 mol); methyltributylammonium chloride (108 g of a 70 wt. % aqueous solution); methylene chloride (12 L); de-ionized water (33 L), para-cumyl phenol (75 g, 0.36 mol) and sodium gluconate (30 g). The mixture was charged with phosgene (3430 g, 200 g/min, 34.7 mol). During the addition of phosgene, base (50 wt. % NaOH in deionized water) was simultaneously charged to the reactor to maintain the pH of the reaction between 6 and 8. After the complete addition of phosgene, the reaction mixture was adjusted to a pH of 10, and the polysiloxane diol of formula (16) (where E is about 44; 650 g) and methylene chloride (2 L) were added. The reaction mixture was stirred for 10 to 15 minutes at pH 11 to 13. Subsequently, additional bisphenol of formula (15) (2565 g, 11.25 mol) and cyclohexylidene bisphenol of formula (14)(2850 g, 9.6 mol) were added, together with methylene chloride (15 L), de-ionized water (18 L), and (n) para-cumyl phenol (285 g, 1.35 mol). The mixture was charged with phosgene (2000 g, 200 g/min, 20.2 mol). During the addition of phosgene, base (50 wt. % NaOH in deionized water) was simultaneously charged to the reactor to maintain the pH of the reaction between 9 and 10. Subsequently, triethylamine (105 mL) and methylene chloride (3 L) was added to the reactor. The mixture was charged with phosgene (1462 g, 200 g/min, 14.8 mol). During the addition of phosgene, base (50 wt. % NaOH in deionized water) was simultaneously charged to the reactor to maintain the pH of the reaction between 9 and 10. After the complete addition of phosgene, the reaction mixture was purged with nitrogen gas, and the organic layer was extracted. The organic extract was washed once with dilute hydrochloric acid (HCl), and subsequently washed with de-ionized water three times. The organic layer was precipitated from methylene chloride into hot steam. The polymer was dried in an oven at 110° C. before analysis. The weight average molecular weight (Mw) of the polycarbonate was measured to be 23,000 g/mol (referenced to polycarbonate standards) and the polydispersity index was 2.6.

### EXAMPLE 2

The following were added into a 270 L CSTR equipped with an overhead condenser and a recirculation pump with a flow rate of 40 L/minute: the cyclohexylidene bisphenol of formula (14) (5700 g, 19.3 mol); methyltributylammonium chloride (108 g of a 70 wt. % aqueous solution); methylene chloride (12 L); de-ionized water (33 L); para-cumyl phenol (75 g, 0.36 mol); and sodium gluconate (30 g). The mixture was charged with phosgene (3430 g, 200 g/min, 34.7 mol). During the addition of phosgene, base (50 wt. % NaOH in deionized water) was simultaneously charged to the reactor to maintain the pH of the reaction between 6 and 8. After the complete addition of phosgene, the reaction mixture was adjusted to a pH of 10, and the diol of formula (16) (where E is about 44; 650 g) and methylene chloride (5.1 L) were added. The reaction mixture was stirred for 10 and 15 minutes at pH 11 to 13. Subsequently, the following was added to the reactor: the bisphenol of formula (15) (5130 g, 22.5 mol); (methylene chloride (15 L); de-ionized water (18 L), and para-cumyl phenol (285 g, 1.35 mol). The mixture was charged with phosgene (2000 g, 200 g/min, 20.2 mol). During the addition of phosgene, base (50 wt. % NaOH in deionized water) was simultaneously charged to the reactor to maintain the pH of the reaction between 9 and 10. Subsequently, triethylamine (105 mL) and methylene chloride (3 L) was added to the reactor. The mixture was charged with phosgene (1462 g, 200 g/min, 14.8 mol). During the addition of phosgene, base (50 wt. % NaOH in deionized water) was simultaneously charged to the reactor to maintain the pH of the reaction between 9 and 10. After the complete addition of phosgene, the reaction mixture was purged with nitrogen gas, and the organic layer was extracted. The organic extract was washed once with dilute hydrochloric acid (HCl), and subsequently washed with de-ionized water three times. The organic layer was precipitated from methylene chloride into hot steam. The polymer was dried in an oven at 110° C. before analysis. The Mw of the polycarbonate was measured to be 23,800 g/mol (referenced to polycarbonate standards) and polydispersity index was 2.7.

### EXAMPLE 3

The following were added into a 270 L CSTR equipped with an overhead condenser and a recirculation pump with a flow rate of 40 L/minute: the bisphenol of formula (15) (770 g, 3.4 mol); the cyclohexylidene bisphenol of formula (14) (4844 g, 16.4 mol); methyl-tributylammonium chloride (108 g of a 70 wt. % aqueous solution); methylene chloride (12 L); de-ionized water (33 L); para-cumyl phenol (75 g, 0.36 mol); and sodium gluconate (30 g). The mixture was charged with phosgene (3430 g, 200 g/min, 34.7 mol). During the addition of phosgene, base (50 wt. % NaOH in deionized water) was simultaneously charged to the reactor to maintain the pH of the reaction between 6 to 8. After the complete addition of phosgene, the reaction mixture was adjusted to a pH of 10, and the diol of formula (16) (where E is about 44; 670 g) and methylene chloride (5.1 L) were added to the reactor. The reaction mixture was stirred for 10 to 15 minutes at pH 11 to 13. Subsequently, the following was added to the reactor: the bisphenol of formula (15) (770 g, 3.4 mol); the cyclohexylidene bisphenol of formula (14) (4844 g, 16.4 mol); methylene chloride (17 L); de-ionized water (20 L); and para-cumyl phenol (260 g, 1.23 mol). The mixture was charged with phosgene (2000 g, 200 g/min, 20.2 mol). During the addition of phosgene, base (50 wt. % NaOH in deionized water) was simultaneously charged to the reactor to maintain the pH of the reaction between 9 to 10. Subsequently, triethylamine (105 mL) and methylene chloride (3.5 L) was added to the reactor. The mixture was charged with phosgene (1462 g, 200 g/min, 14.8 mol). During the addition of phosgene, base (50 wt. % NaOH in deionized water) was simultaneously charged to the reactor to maintain the pH of the reaction between 9 to 10. After the complete addition of phosgene, the reaction mixture was purged with nitrogen gas, and the organic layer was extracted. The organic extract was washed once with dilute hydrochloric acid (HCl), and subsequently washed with de-ionized water three times. The organic layer was precipitated from methylene chloride into hot steam. The polymer was dried in an oven at 110° C. before analysis. The Mw of the polycarbonate was measured to be 20,400 g/mol (referenced to polycarbonate standards) and polydispersity index was 3.2.

### EXAMPLE 4

The following were added into a 270 L CSTR equipped with an overhead condenser and a recirculation pump with a flow rate of 40 L/minute: (a) the bisphenol of formula (15) (770 g, 3.4 mol); the cyclohexylidene bisphenol of formula (14) (4844 g, 16.4 mol); methyl-tributylammonium chloride (108 g of a 70 wt. % aqueous solution); methylene chloride (12 L); de-ionized water (33 L); para-cumyl phenol (75 g, 0.36 mol); and sodium gluconate (30 g). The mixture was charged with phosgene (3430 g, 200 g/min, 34.7 mol). During the addition of phosgene, base (50 wt. % NaOH in deionized water) was simultaneously charged to the reactor to maintain the pH of the reaction between 6 to 8. After the complete addition of phosgene, the reaction mixture was adjusted to a pH of 10, and the diol of formula (16) (where E is about 44; 670 g) and methylene chloride (5.1 L) were added to the reactor. The reaction mixture was stirred for 10 to 15 minutes at pH 11 to 13. Subsequently, the following was added to the reactor: the bisphenol of formula (15) (770 g, 3.4 mol); the cyclohexylidene bisphenol of formula (14) (4844 g, 16.4 mol); methylene chloride (17 L); de-ionized water (20 L); and para-cumyl phenol (235 g, 1.11 mol). The mixture was charged with phosgene (2000 g, 200 g/min, 20.2 mol). During the addition of phosgene, base (50 wt. % NaOH in deionized water) was simultaneously charged to the reactor to maintain the pH of the reaction between 9 to 10. Subsequently, triethylamine (105 mL) and methylene chloride (3.5 L) was added to the reactor. The mixture was charged with phosgene (1462 g, 200 g/min, 14.8 mol). During the addition of phosgene, base (50 wt. % NaOH in deionized water) was simultaneously charged to the reactor to maintain the pH of the reaction between 9 to 10. After the complete addition of phosgene, the reaction mixture was purged with nitrogen gas, and the organic layer was extracted. The organic extract was washed once with dilute hydrochloric acid (HCl), and subsequently washed with de to ionized water three times. The organic layer was precipitated from methylene chloride into hot steam. The polymer was dried in an oven at 110° C. before analysis. The Mw of the polycarbonate was measured to be 25,960 g/mol (referenced to polycarbonate standards) and polydispersity index was 3.5.

Samples of the copolycarbonates of Examples 1 to 4 were injection molded and tested in accordance with the test methods set forth above. The properties are shown in Table 1.

Further in Table 1, the relative mole percent (mol %) of units derived from monomer (14) was calculated from moles of monomer (14) charged into the reactor divided by the sum of the moles of monomer (14) and monomer (15) charged to the reactor. The mol percent of units derived from monomer (15) was calculated from moles of monomer (15) charged to the reactor divided by the sum of the amount of moles of monomer (14) plus monomer (15) charged to the reactor. The wt. % of units derived from monomer (16) was calculated from the weight of monomer (16) charged to the reactor divided by the sum of the weights of monomers (14), (15), (16), and p-cumyl phenol charged to the reactor.

TABLE 1

| | Units | Units | Units | | | |
|---|---|---|---|---|---|---|
| | derived | derived | derived | | NI Impact | |
| | from (14) | from (15) | from (16) | % Haze | Strength | Tg |
| | (mol %) | (mol %) | (wt. %) | (3.2 mm) | (J/m²) | (° C.) |
| Ex. 1 | 46 | 54 | 5.7 | 20 | 24.1 | 145 |
| Ex. 2 | 46 | 54 | 5.7 | 9 | 31.1 | 150 |
| Ex. 3 | 83 | 17 | 5.6 | 2 | — | 133 |
| Ex. 4 | 83 | 17 | 5.6 | 2 | — | 138 |

The data in the table indicate that transparent terpolymers can be obtained from compositions containing greater than 40 mol %, and in particular greater than 60 mol % DMBPC, and less than 60 mol % Bisphenol A, in particular less than 40 mol % Bisphenol A, using the methods outlined in the examples above. Example 2 has improvement in transparency compared to Example 1, due to the modified chloroformate method, which generated chloroformates of monomer (14) that would react with monomer (16) before monomer (16) could be contacted with monomer (15). The data in the table also indicates that clear, translucent copolymers may be generated at less than 60 mol % DMBPC.

The singular forms “a,” “an,” and “the” include plural referents unless the context clearly dictates otherwise. Unless defined otherwise, technical and scientific terms used herein have the same meaning as is commonly understood by one of skill in the art to which this invention belongs. The endpoints of all ranges directed to the same component or property are inclusive and independently combinable. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or can not occur, and that the description includes instances where the event occurs and instances where it does not. All references are incorporated herein by reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. The term “substituted” as used herein means that any at least one hydrogen on the designated atom or group is replaced with another group, provided that the designated atom's normal valence is not exceeded. When the substituent is oxo (i.e., ═O), then two hydrogens on the atom are replaced. Also as used herein, the term “combination” is inclusive of blends, mixtures, alloys, reaction products, and the like.

The term “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “cycloalkyl” refers to a non-aromatic monovalent monocyclic or multicyclic hydrocarbon group having at least three carbon atoms; “cycloalkylene” refers to a non-aromatic divalent monocylic or multicyclic hydrocarbon group having at least three carbon atoms; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “arylenealkyl” refers to a divalent arylalkyl group wherein one point of attachment is on the aryl group and one point of attachment is on the alkyl group; “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

An “organic group” as used herein means a saturated or unsaturated (including aromatic) hydrocarbon having a total of the indicated number of carbon atoms and that can be unsubstituted or unsubstituted with one or more of halogen, nitrogen, sulfur, or oxygen, provided that such substituents do not significantly adversely affect the desired properties of the composition, for example transparency, heat resistance, or the like. Exemplary substituents include alkyl, alkenyl, akynyl, cycloalkyl, aryl, alkylaryl, arylalkyl, —NO2, SH, —CN, OH, halogen, alkoxy, aryloxy, acyl, alkoxy carbonyl, and amide groups.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A copolycarbonate comprising
40 to 89 mol % of units derived from a bisphenol of formula (1) 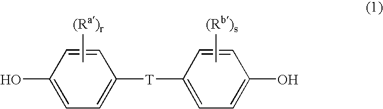
wherein R^{a′} and R^{b′} are each independently C₁₋₁₂ alkyl, T is a C₅₋₁₆ cycloalkylene, a C₅₋₁₆ cylcloalkyliden, a C₁₋₅ alkylene, a C₁₋₅ alkylidene, a C₆₋₁₃ arylene, a C₇₋₁₂ arylalkylene, C₇₋₁₂ arylalkylidene, a C₇₋₁₂ alkylarylene, or a C₇₋₁₂ arylenealkyl, and r and s are each independently 1 to 4;
2 to 35 wt. % of units derived from a polysiloxane diol of formulas (2a) and/or (2b) 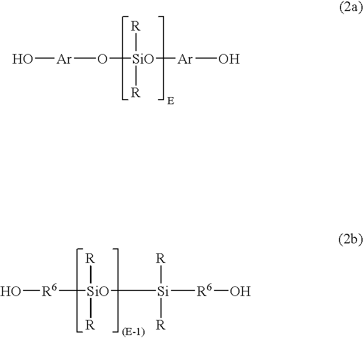
or a combination thereof, wherein Ar is a substituted or unsubstituted C₆₋₃₆ arylene group, each R is the same or different C₁₋₁₃ monovalent organic group, each R⁶ is the same or different divalent C₁-C₃₀ organic group, and E is an integer from 4 to 100; and
11 to 60 mol % of units derived from a dihydroxy aromatic compound of formula (3) 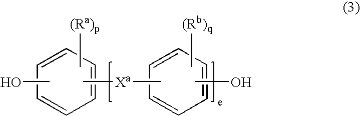
wherein R^{a} and R^{b} are each independently a halogen, X^{a} is a direct bond or a C₁₋₁₈ organic group, p and q are each independently integers of 0 to 4, e is 0 to 1, and the dihydroxy aromatic compound is not the same as the bisphenol (1) or the polysiloxane diol(s); and
wherein each of the foregoing mole percents is based on the total moles of bisphenol of formula (1) and dihydroxy aromatic compound of formula (3) used to manufacture the copolycarbonate, and the weight percent is based on the total weight of the bisphenol of formula (1), polysiloxane diols of formula (2a) and/or (2b), and dihydroxy aromatic compound of formula (3) used to manufacture the copolycarbonate; and further wherein
a molded sample consisting of the copolycarbonate has a haze of less than about 25%, measured using 3.2 mm thick plaques according to ASTM-D1003-00.

2. The copolycarbonate of claim 1, wherein a molded sample consisting of the copolycarbonate has a haze of less than about 5%, measured using 3.2 mm thick plaques according to ASTM-D1003-00.

3. The copolycarbonate of claim 1, wherein T is of the formula 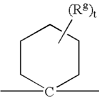
wherein R^{g} is C₁₋₁₂ alkyl or halogen, and t is 0 to 10.

4. The copolycarbonate of claim 3, wherein R^{a′} and R^{b′} are each independently C₁₋₄ alkyl, R^{g} is C₁₋₄ alkyl, r and s are each independently 1 to 2, t is 0 to 5, and R^{a′} and R^{b′} are each disposed meta to the cycloalkylidene bridge.

5. The copolycarbonate claim 1, wherein Ar is a substituted or unsubstituted C₆₋₁₂ arylene group, each R is the same C₁₋₄ alkyl group, each R⁶ is the same or different divalent C₁-C₃₀ organic group, and E is an integer from 4 to 60.

6. The copolycarbonate of claim 1, wherein the polysiloxane diol is of the formula: 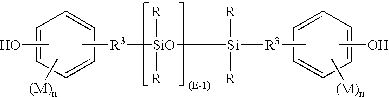
wherein E has an average value of 4 to 60, each R is a C₁₋₃ alkyl group, each R³ is independently a divalent C₂₋₈ aliphatic group, each M is the same or different and is a halogen, cyano, nitro, C₁₋₈ alkylthio, C₁₋₈ alkyl, C₁₋₈ alkoxy, C₂₋₈ alkenyl, C₂₋₈ alkenyloxy group, C₃₋₈ cycloalkyl, C₃₋₈ cycloalkoxy, C₆₋₁₀ aryl, C₆₋₁₀ aryloxy, C₇₋₁₂ arylalkyl, C₇₋₁₂ arylalkoxy, C₇₋₁₂ alkylaryl, or C₇₋₁₂ alkylaryloxy, and each n is independently 0 to 4.

7. The copolycarbonate of claim 6, wherein M is bromo, chloro, a C₁₋₃ alkyl group, a C₁₋₃ alkoxy group, phenyl, chlorophenyl, or tolyl; R³ is a dimethylene, trimethylene or tetramethylene group; and R is a C₁₋₈ alkyl, trifluoropropyl, cyanoalkyl, phenyl, chlorophenyl or tolyl.

8. The copolycarbonate of claim 6, wherein R is methyl, a combination of methyl and trifluoropropyl, or a combination of methyl and phenyl; M is methoxy, n is 1, and R³ is a divalent C₁-C₃ aliphatic group.

9. The copolycarbonate of claim 1, wherein p and q are 0 to 1, e is 1, X^{a} is disposed para to each of the hydroxyls on the phenyl rings, and X^{a} is 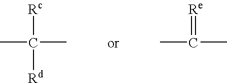
wherein R^{c} and R^{d} are each independently hydrogen, C₁₋₁₂ alkyl, cyclic C₁₋₁₂ alkyl, C₇₋₁₂ arylalkyl, C₁₋₁₂ heteroalkyl, or cyclic C₇₋₁₂ heteroarylalkyl, and R^{e} is a divalent C₁₋₁₂ hydrocarbon group.

10. The copolycarbonate of claim 9, wherein p is 0 and R^{c} and R^{d} are each independently C₁₋₃ alkyl.

11. The copolycarbonate of claim 1, wherein p and q are 0 to 1, e is 1, and X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylene group or a C₆₋₁₆ arylene group.

12. A copolycarbonate comprising
70 to 88 mol % of units derived from a cyclohexylidene bisphenol of the formula 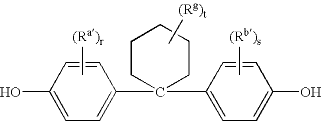
wherein R^{a′} and R^{b′} are each independently C₁₋₃ alkyl, R^{g} is C₁₋₃ alkyl or halogen, r and s are each independently 1 to 2, and t is 0 to 5;
3 to 8 wt. % of units derived from a polysiloxane diol of the formulas 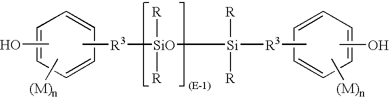
wherein each R is the same or different C₁₋₁₃ monovalent organic group, each R³ is the same or different divalent C₁-C₈ aliphatic group, M is bromo, chloro, a C₁₋₃ alkyl group, a C₁₋₃ alkoxy group, phenyl, chlorophenyl, or tolyl, and E is an integer from 5 to 55; and
12 to 30 mol % of units derived from a dihydroxy aromatic compound of formula 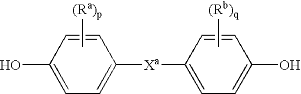
wherein R^{a} and R^{b} are each independently a halogen, X^{a} is a C₁₋₁₈ alkylene group, a C₃₋₁₈ cycloalkylene group, or a fused C₆₋₁₈ cycloalkylene group, p and q are each independently integers of 0 to 1, and the dihydroxy aromatic compound is not the same as the cyclohexylidene bisphenol or the polysiloxane diols; and further wherein
a molded sample consisting of the composition has a haze of less than about 5%, measured using 3.2 mm thick plaques according to ASTM-D1003-00.

13. A copolycarbonate comprising
70 to 88 mol % of units derived from a cyclohexylidene bisphenol of the formula 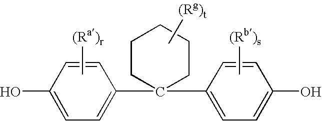
wherein r and s are each 1, R^{a′} and R^{b′} are each a methyl group disposed meta to the cyclohexylidene ring, R^{g} is C₁₋₃ alkyl or halogenand t is 0 to 5;
3 to 8 wt. % of units derived from a polysiloxane diol of the formula 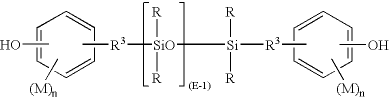
wherein each R is methyl, ach R³ is proplyene, M is bromo, chloro, a C₁₋₃ alkyl group, a C₁₋₃ alkoxy group, phenyl, chlorophenyl, or tolyl, and E is an integer from 5 to 55; and
12 to 30 mol % of units derived from a dihydroxy aromatic compound of formula 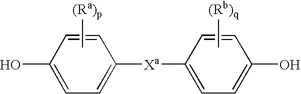
wherein p and q is each 0, X^{a} is isopropyledene; and further wherein a molded sample consisting of the composition has a haze of less than about 5%, measured using 3.2 mm thick plaques according to ASTM-D1003-00.

14. A method of manufacture of a polycarbonate copolymer, comprising
reacting the components of claim 1 and a carbonyl precursor in a biphasic solvent in the presence of a phase transfer catalyst and sufficient caustic to maintain a pH of 6 to 13.

15. The method of claim 14, wherein the reacting comprises generating a chloroformate of the compound of formula (1) and a chloroformate of the compound of formula (3) in a biphasic solvent in the presence of a phase transfer catalyst and sufficient caustic to maintain a pH of 6 to 8; then reacting the chloroformates with the polysiloxane diols of formulas (2a) and/or (2b) at a pH of 11 to 13 in the presence of phosgene.

16. The method of claim 14, wherein the reacting comprises generating the chloroformate of the compound of formula (1) in a biphasic solvent in the presence of a phase transfer catalyst and sufficient caustic to maintain a pH of 6 to 8; then reacting the chloroformate with the polysiloxane diols of formulas (2a) and/or (2b) at a pH of 11 to 13 in the presence of phosgene.

17. A thermoplastic composition, comprising the copolycarbonate of claim 1 and an additive.

18. The thermoplastic composition of claim 17, wherein the additive is an impact modifier, a filler, an ionizing radiation stabilizer, an antioxidant, a heat stabilizer, a light stabilizer, an ultraviolet light absorber, a plasticizer, a lubricant, a mold release agent, an antistatic agent, a pigment, a dye, a flame retardant, an anti-drip agent, or a combination comprising at least one of the foregoing additives.

19. The thermoplastic composition of claim 17, wherein an article having a thickness of 3.2±0.12 mm and molded from the thermoplastic composition has a haze of less than 3%, measured in accordance with ASTM D1003-00.

20. A method of manufacture of a thermoplastic composition, comprising blending the polycarbonate copolymer of claim 1 with an additive to form a thermoplastic composition.

21. An article, comprising the thermoplastic composition of claim 17.

22. The article of claim 21, wherein the article is a syringe barrel, sample container, medicaments container, plastic vial, blood housing, membrane housing, or a syringe plunger.

23. A method of manufacture of an article, comprising molding, extruding, or shaping the thermoplastic composition of claim 17 into an article.
